(19) United States
(12) Patent Application Publication
(10) Pub. No.: US 2023/0137143 A1
(43) Pub. Date: May 4, 2023

(54) WORK MACHINE

(71) Applicant: MAKITA CORPORATION, Anjo-shi (JP)

(72) Inventors: Hideaki TAKANO, Anjo-shi (JP); Hirofumi MIYAZATO, Anjo-shi (JP)

(73) Assignee: MAKITA CORPORATION, Anjo-shi (JP)

(21) Appl. No.: 17/969,219

(22) Filed: Oct. 19, 2022

(30) Foreign Application Priority Data
Oct. 28, 2021 (JP) 2021-176675

(51) Int. Cl. A47L 9/00; G10K 11/178

(52) U.S. Cl. CPC A47L 9/0081; G10K 11/17883

(57) ABSTRACT

A work machine includes a housing. The housing at least partly houses a machine. The housing has an opening. The work machine includes a path leading into the housing from the opening. The work machine includes a controller and a speaker. The controller is configured to cause a speaker to output a control sound for reducing operating noise. The operating noise is generated in the housing by motion of the machine and propagates in the path from a source of the operating noise to the opening. The speaker is arranged so that the control sound propagates in the path with its wavefront parallel to a wavefront of the operating noise that propagates in the path.

### CROSS-REFERENCE TO RELATED APPLICATIONS

This application claims the benefit of Japanese Patent Application No.

2021-176675 filed on Oct. 28, 2021 with the Japan Patent Office, the entire disclosure of which is incorporated herein by reference.

### BACKGROUND

The present disclosure relates to a work machine.

U.S. Patent Application Publication No. 2019/0275657 discloses an electric power tool to which active noise control (ANC) is applied. ANC is a technique for canceling noise by using sound collected by a microphone to generate a sound having an inverted phase of the noise from a speaker at a location where the noise is desired to be canceled.

### SUMMARY

There is still room for improvement in the noise reduction effect of the existing ANC. In a work machine where mechanical operating noise propagates from inside the housing to outside through an opening, the technique for effectively inhibiting the operating noise propagating outside is not yet known.

Therefore, one aspect of the present disclosure is to provide a technique for effectively reducing the operating noise that propagates outside, in a work machine where the operating noise propagates from inside a housing to outside through an opening.

According to one aspect of the present disclosure, a work machine is provided. The work machine includes a machine. The work machine includes a housing. The housing at least partly houses the machine. The housing has an opening.

The work machine further has a path leading into the housing from the opening. The work machine further includes a controller and a speaker. The controller is configured to cause the speaker to output a control sound for reducing operating noise. The operating noise is generated in the housing by motion of the machine and propagates in the path from a source of the operating noise to the opening.

The speaker is arranged so that the control sound propagates in the path with its wavefront parallel to a wavefront of the operating noise that propagates in the path. The above arrangement of the speaker can effectively reduce the operating noise that propagates in the path by the control sound with the wavefront parallel to the wavefront of the operating noise.

As a result, according to one aspect of the present disclosure, it is possible to effectively reduce the operating noise that propagates outside the housing from the opening through the path, and provide a work machine in which the operating noise audible to an operator is low.

According to another aspect of the present disclosure, in order to effectively reduce the operating noise that propagates outside the housing in a work machine where the operating noise propagates outside through the opening, a work machine according to the following items 1 and 2 may be provided.

[Item 1]

A work machine comprising:

a machine;

a housing that at least partly houses the machine, the machine having an opening;

a speaker;

a microphone configured to collect sound and output a sound signal that is an electrical signal corresponding to the sound collected; and

a controller configured to cause the speaker to output a control sound for reducing operating noise based on the sound signal from the microphone, the operating noise being generated in the housing by motion of the machine and propagating outside the housing through the opening, wherein the opening is an open end of the housing, wherein the speaker is arranged to have a vibrating surface along a boundary plane between inside and outside the housing defined by the open end, and is configured to output the control sound from both sides of the vibrating surface in a direction normal to the vibrating surface, and wherein the microphone is arranged within a specific distance centered on the vibrating surface in the direction normal to the vibrating surface, and the specific distance corresponds to a quarter wavelength of the operating noise.

[Item 2]

The work machine according to item 1, wherein the microphone is arranged within a distance corresponding to half a quarter wavelength or one-sixth wavelength of the operating noise as the specific distance.

According to the work machine according to item 1, the operating noise that propagates outside the housing through the opening can be effectively reduced by the arrangement of the speaker and the microphone. The work machine according to item 2 improves noise reduction effect.

### BRIEF DESCRIPTION OF THE DRAWINGS

Example embodiments of the present disclosure will be described hereinafter with reference to the accompanying drawings, in which:

FIG. 1 is a perspective view showing the appearance of a dust collector according to one example embodiment;

FIG. 2 is a bottom view of a dust collector main body;

FIG. 3 is a perspective view of a rear housing with its internal components removed, as seen from a joining surface between a front housing and the rear housing;

FIG. 4 is a perspective view showing an interior of the dust collector with the rear housing removed from the collector main body;

FIG. 5 is a perspective view of the front housing with its internal components removed, as seen from the joining surface between the front housing and the rear housing;

FIG. 6 is a partly enlarged plan view of the front housing, as seen from the joining surface between the front housing and the rear housing;

FIG. 7 is a diagram conceptually illustrating the relationship between wavefronts of target noise and wavefronts of control sound;

FIG. 8 is a block diagram showing an electrical configuration of the dust collector;

FIG. 9 is a block diagram showing a feed-forward ANC model;

FIG. 10 is a perspective view of the front housing of the dust collector of a variation, with its internal components removed, as seen from a joining surface between the front housing and the rear housing;

FIG. 11 is a partly enlarged plan view of the front housing of the dust collector of the variation, as seen from the joining surface between the front housing and the rear housing;

FIG. 12 is a diagram conceptually illustrating the relationship between wavefronts of target noise and wavefronts of control sound in the dust collector of the variation;

FIG. 13 is a side view of a blower;

FIG. 14 is a perspective view of the blower;

FIG. 15 is a perspective sectional view of the blower; and

FIG. 16 is a block diagram illustrating a feedback ANC model.

### DETAILED DESCRIPTION OF EXEMPLARY EMBODIMENTS

### 1. Overview of Embodiments

### 1.1. First Embodiment

A work machine in one embodiment may include a machine. The machine may be configured to work for a specific operation. Additionally or alternatively, the work machine may include a housing. The housing may at least partly house the machine. Additionally or alternatively, the housing may have an opening.

Additionally or alternatively, the work machine may include a path leading into the housing from the opening. Additionally or alternatively, the work machine may include a speaker. Additionally or alternatively, the work machine may include a controller. The controller may be configured to cause the speaker to output a control sound.

The control sound may be a sound that reduces sound that propagates in the path to the opening. For example, the control sound may reduce operating noise that is generated in the housing by motion of the machine and propagates in the path from a source of the operating noise to the opening.

The speaker may be arranged so that the control sound propagates in the path with its wavefront parallel to a wavefront of the operating noise. The control sound propagating with its wavefront parallel to the wavefront of the operating noise makes it possible to effectively reduce the operating noise that propagates in the path.

As a result, the work machine can effectively reduce the operating noise that propagates outside the housing from the opening. Specifically, it is possible to provide a work machine in which the operating noise audible to an operator is low.

In one embodiment, the path may be designed so that the operating noise that propagates in the path forms a plane wave with a wavefront orthogonal to an axial direction of the path. The speaker may output the control sound in the axial direction of the path so that the control sound propagates as a plane wave with a wavefront orthogonal to the axial direction of the path. Such design of the path and output of the control sound can effectively reduce the operating noise that propagates in the path.

In one embodiment, the path may include a first path and a second path that is coupled to the first path. The first path may be a first linear path. The second path may be a second linear path. The second linear path may be coupled to the first linear path at an angle to the first linear path. For example, the second linear path may be coupled to the first linear path at right angles.

In one embodiment, when the first path is coupled to the second path, the speaker may be arranged on a side wall of a coupling portion between the first path and the second path. The speaker may be arranged so as to face the first path or the second path on the side wall of the coupling portion, and output the control sound in an axial direction of the first path or the second path.

In one embodiment, the speaker may be arranged on a side wall of the coupling portion between the first linear path and the second linear path in the path. The speaker may be arranged so as to face the first linear path or the second linear path on the side wall of the coupling portion, and output the control sound in an axial direction of the first linear path or the second linear path. Such use of the coupling portion of the path allows the speaker to be arranged so that the wavefront of the control sound are parallel to a wavefront of the operating noise.

In one embodiment, the speaker may be arranged so as to output the control sound in the same direction as a propagation direction of the operating noise that propagates to the opening. The speaker may be arranged so as to output a control sound with its wavefront parallel to a wavefront of the operating noise as the control sound that propagates in the same direction as the propagation direction of the operating noise. This arrangement can effectively reduce the operating noise that is about to propagate outside the housing.

In one embodiment, the speaker may be arranged so as to output the control sound in a direction opposite to a propagation direction of the operating noise that propagates to the opening. The speaker may be arranged so as to output a control sound with a wavefront parallel to a wavefront of the operating noise as the control sound that propagates in the direction opposite to the propagation direction of the operating noise. This arrangement can effectively reduce the operating noise that is about to propagate outside the housing.

### 1.2. Second Embodiment

A work machine in one embodiment may include a machine. The machine may be configured to work for a specific operation. Additionally or alternatively, the work machine may include a housing. The housing may at least partly house the machine. Additionally or alternatively, the housing may have an opening.

In one embodiment, the work machine may include a speaker and a microphone. The microphone may collect sound, and output a sound signal that is an electrical signal corresponding to the collected sound. In one embodiment, the work machine may include a controller.

The controller may be configured to cause the speaker to output a control sound for reducing sound that propagates outside the housing through the opening based on the sound signal from the microphone. For example, the controller may be configured to cause the speaker to output a control sound for reducing operating noise. The operating noise is generated in the housing by motion of the machine and propagates outside the housing through the opening.

In one embodiment, the opening may be an open end of the housing. The speaker may be arranged to have a vibrating surface at the open end. Alternatively, the speaker may be arranged to have a vibrating surface along a boundary plane between inside and outside the housing defined by the open end. The speaker may be arranged so that the vibrating surface coincides with the boundary plane or is in front of or behind the boundary plane. The speaker may be configured to output the control sound from both sides of the vibrating surface in a direction normal to the vibrating surface.

In one embodiment, the microphone may be arranged within a specific distance centered on the vibrating surface or the boundary plane in the direction normal to the vibrating surface or the boundary plane. The specific distance may correspond to a quarter wavelength of the operating noise. Arranging the speaker and the microphone within the above distance makes it possible to effectively reduce the sound that propagates outside the housing from the open end.

In one embodiment, the microphone may be arranged within a distance corresponding to one-sixth wavelength of the operating noise as the specific distance. In one embodiment, the microphone may be arranged within a distance corresponding to half a quarter wavelength of the operating noise as the specific distance. Arranging the speaker and the microphone within the above distance makes it possible to further effectively reduce the sound that propagates outside the housing from the open end.

With respect to the aforementioned first and second embodiments, one or more of the components of the aforementioned work machine may be removed as desired. The work machine may include an additional component as desired. One or more of the components of the work machine may be replaced with another component or components as desired.

### 2. Specific Exemplary Embodiments

### 2.1. First Embodiment

2.1.1. Configuration of Dust Collector

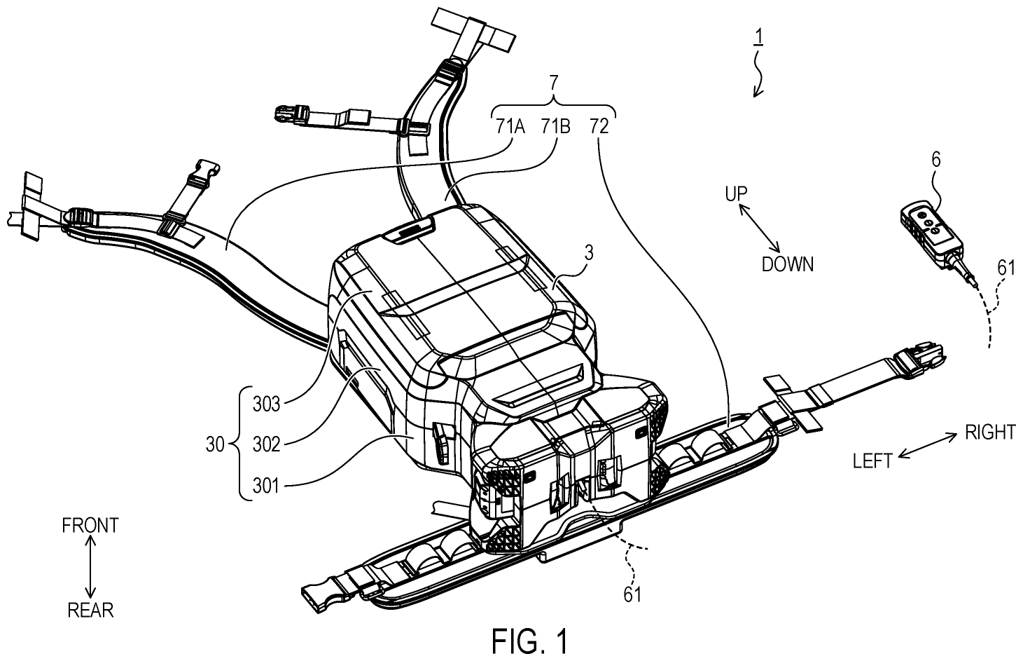

A configuration of a dust collector 1 will be described hereinafter, as an example of a work machine. For convenience of description, the direction (front, rear, up, down, left and right) relative to the dust collector 1 is defined as shown in FIGS. 1 to 6 in the present embodiment.

As shown in FIG. 1, the dust collector 1 of the present embodiment includes a main body 3, an operation device 6, and attachments 7. The attachments 7 include shoulder belts 71A, 71B, and a waist belt 72. The shoulder belts 71A, 71B and the waist belt 72 are attached to the rear surface of the main body 3.

The shoulder belt 71A extends from near the upper left end of the main body 3. The shoulder belt 71B extends from near the upper right end of the main body 3. The waist belt 72 extends from near the bottom end of the main body 3. The attachments 7 are used for an operator of the dust collector 1 to carry the main body 3 on its back.

The operation device 6 includes a switch to start or stop the dust collector 1. The operation device 6 is manipulated by the operator. The operation device 6 is connected, via a cable 61, to the main body 3 near the center of the bottom end of the main body 3.

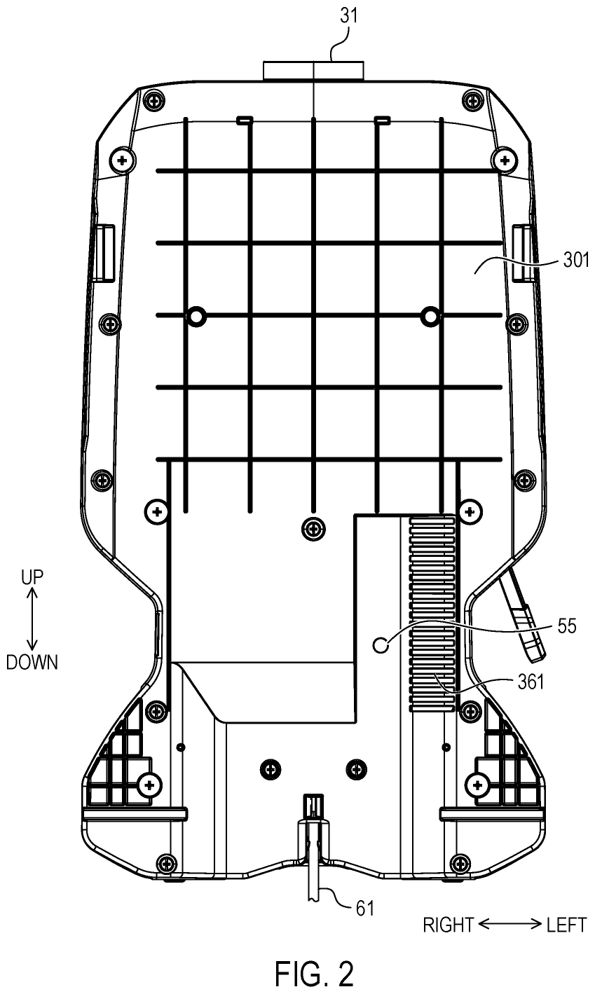

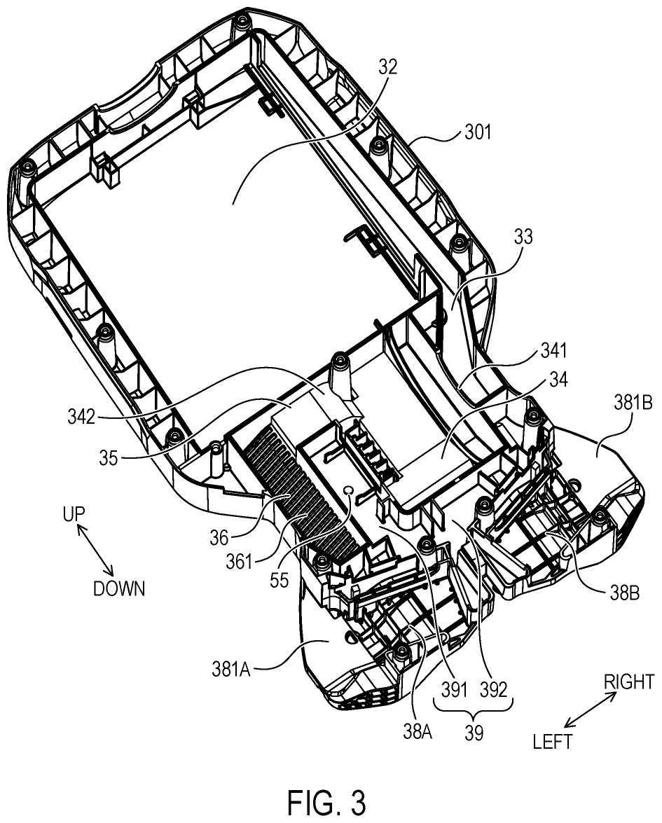

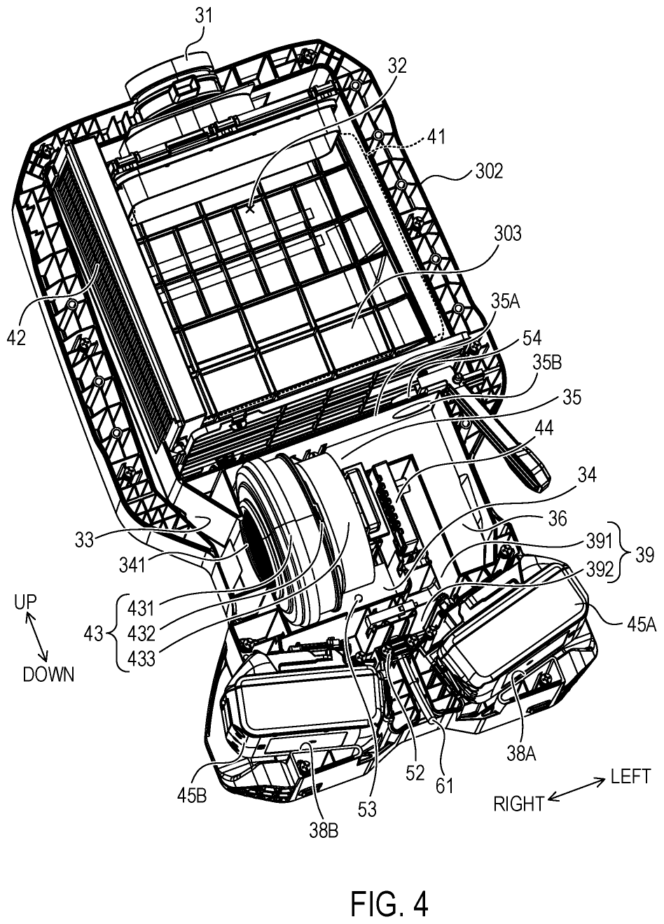

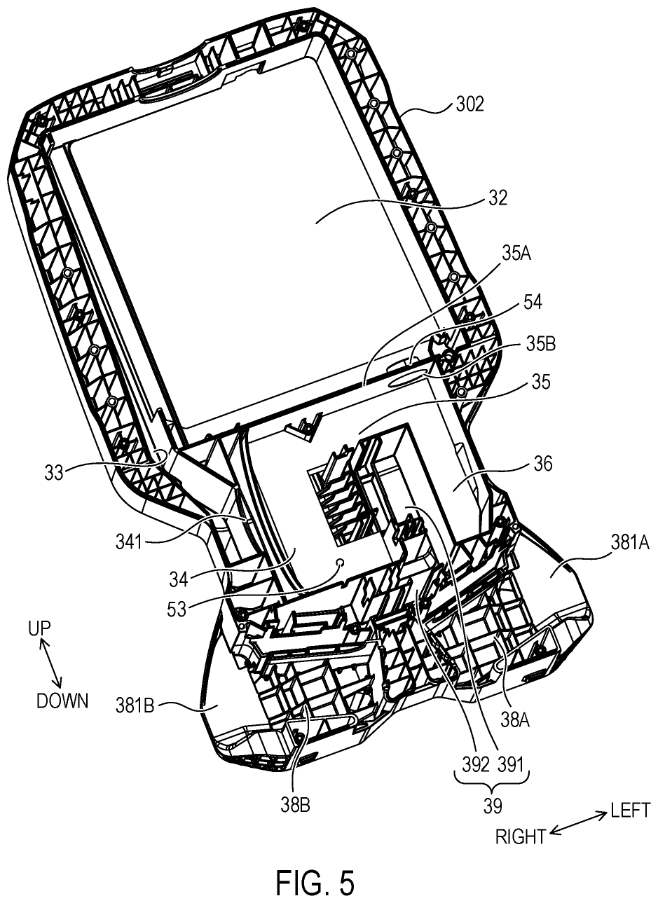

The main body 3 includes a housing 30 for housing major electrical and/or mechanical components of the dust collector 1. The housing 30 includes a rear housing 301, a front housing 302, and a plate 303. FIGS. 2 and 3 show a configuration of the rear housing 301. FIGS. 4 and 5 show a configuration of the front housing 302.

The rear housing 301 is a bottomed box-shaped member having an inner surface facing the front. The front housing 302 is a frame-shaped member with an opening. The plate 303 is a plate-shaped member that closes the opening of the front housing 302 from the front. The housing 30 is, for example, mold by injecting a resin material.

As shown in FIGS. 3, 4, and 5, the housing 30 includes a suction port 31, a dust collecting chamber 32, a first flow path 33, a motor chamber 34, a second flow path 35, a third flow path 36, a first battery compartment 38A, a second battery compartment 38B, and a component placement portion 39.

The suction port 31 is provided in the central portion of the top end of the housing 30. The suction port 31 is connected to a first end of a flexible hose (not shown). A second end of the hose is connected to a nozzle having a suction port (not shown).

As shown in FIG. 4, the dust collecting chamber 32 is a rectangular internal chamber provided on the upper side of the housing 30. The dust collecting chamber 32 stores a dust bag 41 that is connected to the suction port 31. The dust bag 41 is made of, for example, paper. The dust bag 41 traps and collects dust sucked from the suction port 31.

The first flow path 33 is provided along the right side of the dust collecting chamber 32. The bottom end of the first flow path 33 is connected to the motor chamber 34. A filter 42 is arranged at the boundary between the first flow path 33 and the dust collecting chamber 32. Examples of the filter 42 may include a high efficiency particulate air filter (HEPA).

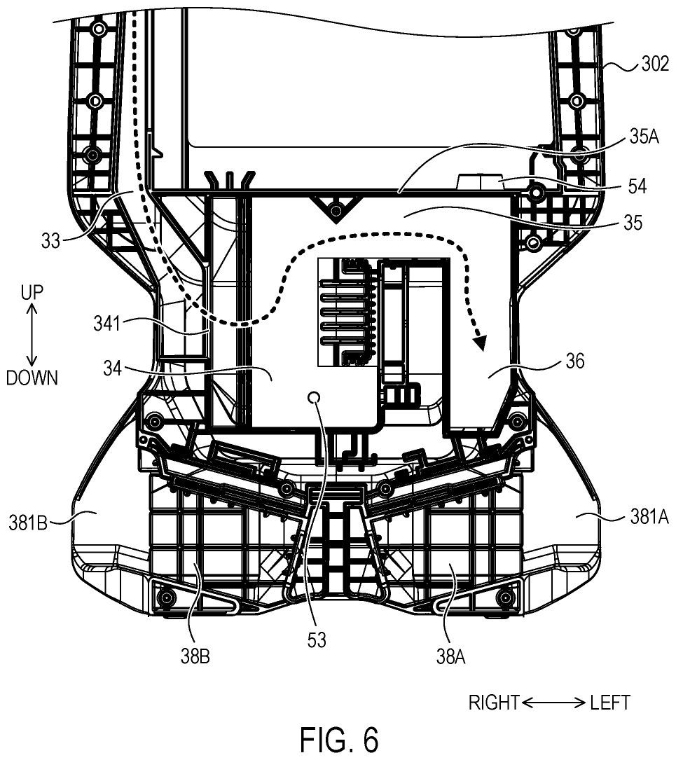

The motor chamber 34 is an internal chamber provided below the dust collecting chamber 32. As shown in FIGS. 3 to 6, the motor chamber 34 includes an inlet port 341 in the central portion of the right end of the motor chamber 34. The inlet port 341 is connected to the first flow path 33. The motor chamber 34 further includes an outlet port 342 in the upper portion of the left end of the motor chamber 34. The outlet port 342 is connected to the second flow path 35. The motor chamber 34 houses a drive machine 43. A thick dotted arrow shown in FIG. 6 conceptually represents an airflow.

The drive machine 43 includes a fan 431, a motor 432, and a damper 433. The fan 431 is connected to a rotation shaft of the motor 432. The fan 431 receives power from the motor 432 and is rotationally driven. As a result, an airflow that travels from the inlet port 341 toward the outlet port 342 of the motor chamber 34 is generated.

The damper 433 is an annular member that covers the motor 432. The damper 433 absorbs noise generated by the motor 432. In FIG. 4, the motor 432 is arranged in the center of the damper 433 although not shown because the motor 432 is covered with the damper 433.

A microphone 53 is also installed in the motor chamber 34. The microphone 53 is used as the reference microphone 53 in active noise control (ANC).

The reference microphone 53 is provided so as to collect operating noise of the drive machine 43 generated in the housing 30. The operating noise includes noise from the motor 432 and the fan 431 due to motion of the drive machine 43. The reference microphone 53 outputs a sound signal that is an electrical signal corresponding to the collected noise.

The second flow path 35 is a linear exhaust path provided on the upper side of the motor chamber 34 and extending leftward from the motor chamber 34. The second flow path 35 connects the outlet port 342 of the motor chamber 34 with the third flow path 36.

The third flow path 36 is a linear exhaust path provided to the left of the motor chamber 34 and extending downward. The third flow path 36 includes an exhaust port 361 in its downstream portion. The third flow path 36 is coupled at an angle to the second flow path 35. Specifically, the third flow path 36 is coupled to the second flow path 35 at right angles. As shown in FIGS. 2 and 3, the exhaust port 361 has the form of a group of slits that are formed on the rear surface of the housing 30.

The second flow path 35 and the third flow path 36 form an L-shaped exhaust path, and controls the airflow from the motor chamber 34 to the exhaust port 361. Specifically, the second flow path 35 and the third flow path 36 guide the airflow from the motor chamber 34 out of the housing 30 through the exhaust port 361.

In the main body 3 configured as above, when airflow is generated by the motion of the drive machine 43, external air is sucked into the internal space of the housing 30 through the suction port 31. The sucked external air first enters the dust collecting chamber 32, and passes through the dust bag 41 attached to the suction port 31. This passing through allows the dust contained in the external air to be trapped.

The air that has passed through the dust bag 41 reaches the first flow path 33 via the filter 42. The air that has reached the first flow path 33 passes through the motor chamber 34 and the second flow path 35 to the third flow path 36, and is discharged to outside the housing 30 through the exhaust port 361.

The operating noise from the drive machine 43 propagates through the exhaust path to the exhaust port 361, and from the exhaust port 361 to outside the housing 30. This operating noise is the noise to be inhibited from propagating outside the housing 30 by ANC (hereinafter, referred to as target noise).

In order to inhibit the target noise from propagating outside the housing 30 through the exhaust port 361, a control speaker 54 is further provided in the exhaust path. The control speaker 54 is provided at a location on the upper side wall 35A of the second flow path 35, the location intersecting with the axis extending in up and down directions of the third flow path 36. The control speaker 54 is arranged so that a vibrating surface of the control speaker 54 faces the third flow path 36.

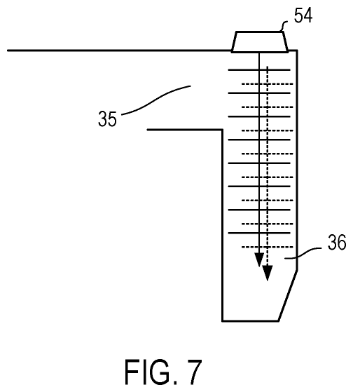

Specifically, the control speaker 54 is configured so that its vibrating surface is orthogonal to the axial direction of the third flow path 36. This arranges the control speaker 54 to output the control sound in the axial direction of the third flow path 36 so that the control sound propagates as a plane wave with wavefronts orthogonal to the axial direction of the third flow path 36, as shown in FIG. 7.

The solid arrow shown in FIG. 7 conceptually represents a propagation direction of the control sound, and the line segments (solid lines) perpendicular to the solid arrow conceptually represent wavefronts of the control sound. The dashed arrow shown in FIG. 7 conceptually represents a propagation direction of the target noise, and the line segments (dashed lines) perpendicular to the dashed arrow conceptually represent wavefronts of the target noise. The control sound is output from the control speaker 54 to cancel the target noise.

A mounting hole 35B for the control speaker 54 is provided on the side wall 35A of the second flow path 35. The control speaker 54 is fitted into the mounting hole 35B to be fixed to the side wall 35A. The control speaker 54 is configured to output the control sound from the front side facing the third flow path 36, and not to output the control sound from the back side.

The target noise that propagates outside the housing 30 from the exhaust port 361 through the third flow path 36 is a plane wave with wavefronts orthogonal to the axial direction of the third flow path 36, as shown by the dashed lines in FIG. 7.

The target noise propagates in such a plane wave because a width in a direction perpendicular to the axis of the third flow path 36 is sufficiently narrow relative to the wavelength of the target noise. Sound that human hears as noise is a sound in the 2 kHz band, and the wavelength of the sound in 2 kHz band is approximately 170 mm.

The second flow path 35 and the third flow path 36 are designed to have a width of 50 mm to 100 mm which is sufficiently smaller than 170 mm. Accordingly, the target noise that propagates in the third flow path 36 forms a plane wave with wavefronts orthogonal to the axial direction of the third flow path 36.

The control speaker 54 outputs the control sound that propagates in the same direction as the target noise that propagates in the third flow path 36 in such a plane wave. The control sound has a plane wave with wavefronts parallel to the wavefronts of the target noise. Since the directions of the wavefronts are aligned between the target noise and the control sound, the target noise is almost uniformly canceled by the control sound in the third flow path 36. In the present embodiment, this largely lowers the level of the target noise that leaks outside from the exhaust port 361.

The first battery compartment 38A of the housing 30 defines a space that houses the first battery pack 45A. The first battery compartment 38A is provided near the bottom end of the housing 30. The first battery compartment 38A includes a first battery mounting port 381A that is open near the lower left end of the housing 30.

The second battery compartment 38B defines a space that houses the second battery pack 45B. The second battery compartment 38B is provided near the bottom end of the housing 30. The second battery compartment 38B includes a second battery mounting port 381B that is open near the lower right end of the housing 30. The first and second battery packs 45A, 45B are respectively inserted from the first and second battery mounting ports 381A, 381B to the first and second battery compartments 38A, 38B.

The component placement portion 39 is an internal space located between the motor chamber 34, the second flow path 35, the third flow path 36, and the first and second battery compartments 38A, 38B. Various electrical components are arranged in this internal space.

The component placement portion 39 includes a vertical portion 391 and a horizontal portion 392 that communicates with the vertical portion 391. The vertical portion 391 corresponds to a portion surrounded on three sides by walls of the motor chamber 34, the second flow path 35, and the third flow path 36. The horizontal portion 392 corresponds to a portion that is placed between the motor chamber 34 and the first and second battery compartments 38A, 38B.

A connector 52 is arranged in the horizontal portion 392. The connector 52 is arranged between the first battery compartment 38A and the second battery compartment 38B. The connector 52 is provided to connect a cable 61 of the operation device 6 with an internal circuit.

A drive controller 44, and an error microphone 55 used in ANC are arranged in the vertical portion 391. The error microphone 55 is mounted to be exposed outside the housing 30 through a mounting hole formed on the bottom surface of the rear housing 301 and to be directional toward the outside of the housing 30.

As shown in FIG. 4, the drive controller 44 is attached to a wall that defines a boundary between the vertical portion 391 and the motor chamber 34. The drive controller 44 is a circuit board that performs power supply control, motor control, noise control, and so on.

The error microphone 55 is arranged at a location corresponding to a noise canceling point and not directly hit by the airflow generated by the drive machine 43. The location corresponding to the noise canceling point is where the error microphone 55 can be assumed to be at the noise canceling point. The location corresponding to the noise canceling point is specifically in the vicinity of the exhaust port 361. In ANC, the control sound is controlled so that the target noise and the control sound cancel each other out at the noise canceling point. The error microphone 55 collects a combined sound of the target noise discharged from the exhaust port 361 and the control sound.

The reference microphone 53, the control speaker 54, and the error microphone 55 are arranged so that time for the control sound emitted from the control speaker 54 to reach the noise canceling point is shorter than time for the target noise to directly reach the noise canceling point. During the time difference, a process to generate the control sound is executed.

[2.1.2. Drive Controller]

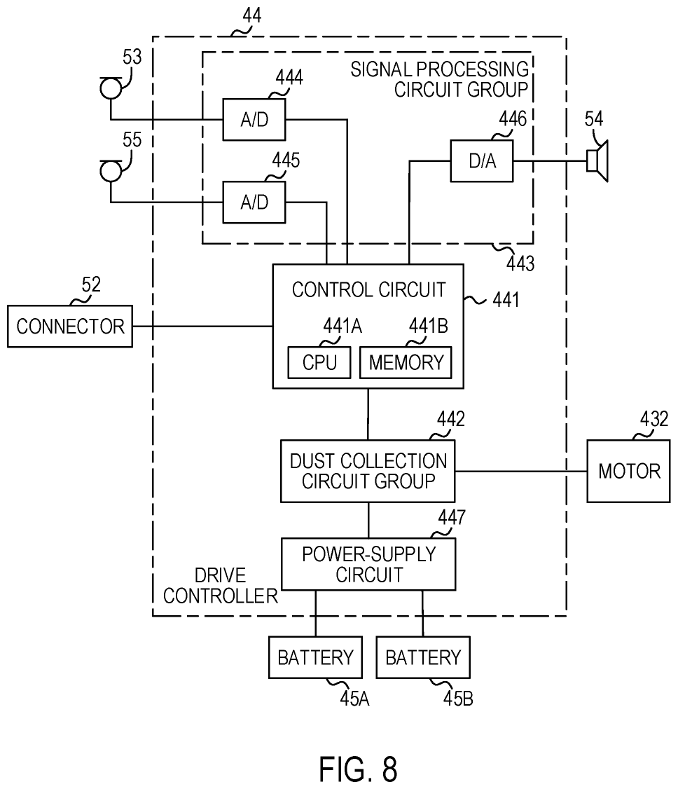

As shown in FIG. 8, the drive controller 44 includes a control circuit 441, a dust collection circuit group 442, a signal processing circuit group 443, and a power-supply circuit 447.

The power-supply circuit 447 delivers electric power supplied from the first and second battery packs 45A, 45B to each part of the dust collector 1 at an appropriate voltage. The control circuit 441 is configured as a microcomputer. The control circuit 441 includes a CPU 441A and a memory 441B.

As another example, the control circuit 441 may include, in place of or in addition to the microcomputer, a combination of electronic components such as, for example, discrete devices. The control circuit 441 may include a digital signal processor (DSP) and/or an application specific IC (ASIC). The control circuit 441 may include an application specific standard product (ASSP). The control circuit 441 may include a programmable logic device.

The dust collection circuit group 442 includes circuits necessary to perform the function as the dust collector 1. Specifically, the dust collection circuit group 442 includes a motor drive circuit and a battery switching circuit. The motor drive circuit drives the motor 432. The battery switching circuit appropriately switches a supply source of electric power between the first and second battery packs 45A, 45B depending on the remaining energies of the first and second battery packs 45A, 45B.

The signal processing circuit group 443 includes various types of circuits necessary to perform the function as a noise controller. The signal processing circuit group 443 includes first and second analog/digital (A/D) converters 444, 445 and a digital/analog (D/A) converter 446.

The first A/D converter 444 converts a sound signal from the reference microphone 53 to a digital signal and supplies the digital signal to the control circuit 441. The second A/D converter 445 converts a sound signal from the error microphone 55 to a digital signal and supplies the digital signal to the control circuit 441. The D/A converter 446 converts control data from the control circuit 441 to analog data in order to generate a control signal to be supplied to the control speaker 54.

The control circuit 441 controls the dust collection circuit group 442. As a result, a process for achieving the function as the dust collector 1 is executed. The control circuit 441 also executes a noise reduction process for reducing the target noise.

The control circuit 441 executes a noise control process. As a result, feed-forward active noise control (ANC) is achieved. By ANC, the control sound for inhibiting the operating noise from propagating outside the housing 30, in other words, the control sound for canceling the target noise, is output from the control speaker 54.

[2.1.3. ANC Model]

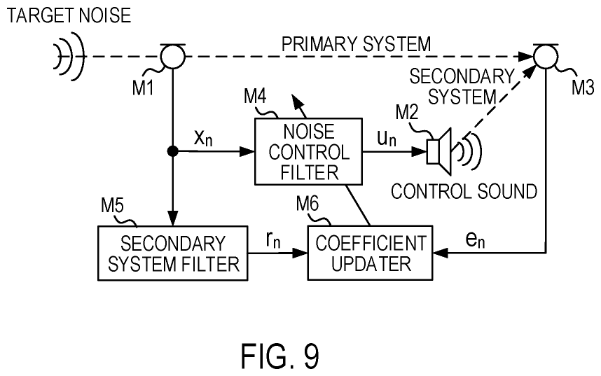

Referring to FIG. 9, the feed-forward ANC model applied to the dust collector 1 will be described. The feed-forward ANC model includes a reference sensor M1, a control sound source M2, an error sensor M3, a noise control filter M4, a secondary system filter M5, and a coefficient updater M6.

The reference sensor M1 corresponds to the reference microphone 53 and the first A/D converter 444. The control sound source M2 corresponds to the D/A converter 446 and the control speaker 54. The error sensor M3 corresponds to the error microphone 55 and the second A/D converter 445.

All of the noise control filter M4, the secondary system filter M5, and the coefficient updater M6 may be implemented by processes of the control circuit 441, that is, software. Alternatively, some or all of the noise control filter M4, the secondary system filter M5, and the coefficient updater M6 may be implemented by hardware.

The reference sensor M1 generates a reference signal xₙ by collecting the target noise. The reference signal xₙ corresponds to a digital signal generated by sampling the sound signal from the reference microphone 53 at a specific sampling cycle. The subscript “n” represents discrete time, and indicates that the corresponding reference signal xₙ is the n^{th} sampling data.

The noise control filter M4 is a finite impulse response (FIR) filter including L taps. “L” is a positive integer. The noise control filter M4 generates a control signal uₙ from an L-dimensional reference vector x(n) having L reference signals {xₙ, xₙ₋₁, x_{n-L+1}} that are most recently detected.

The control sound source M2 produces a control sound in accordance with the control signal uₙ. The error sensor M3 generates an error signal eₙ by collecting the combined sound of the target noise and the control sound. The error signal eₙ corresponds to a digital signal generated by sampling the sound signal from the error microphone 55 at a specific sampling cycle.

Hereinafter, a sound propagation path from the reference sensor M1 to the error sensor M3 is referred to as a primary system, and a sound propagation path from the control sound source M2 to the error sensor M3 is referred to as a secondary system. The secondary system filter M5 is a FIR filter including N taps. “N” is a positive integer. The secondary system filter M5 generates a filtered reference signal rₙ from an N-dimensional reference vector x(n) having N reference signals {xₙ, xₙ₋₁, . . . , x_{n-N+1}} that are most recently detected.

The secondary system filter M5 is a filter modeled on the transfer characteristics of the secondary system. A fixed value is used for a coefficient of each tap. The filtered reference signal rₙ is a signal obtained by adding the influence of the secondary system, which is added to the control sound when the control sound reaches the error sensor M3, to the reference signal xₙ.

The coefficient updater M6 updates the coefficients {w₁, w₂, . . . , w_{L}} of L taps included in the noise control filter M4 based on the filtered reference signal rₙ and the error signal eₙ. The coefficients {w₁, w₂, . . . , w_{L}} are updated so that the target noise and the control sound cancel each other out and the error signal eₙ becomes the smallest at the position of the error sensor M3 (that is, the noise canceling point).

The coefficients of the noise control filter M4 may be updated with, for example, the Filtered-x NLMS algorithm that is one of adaptive algorithms.

Due to the coefficient update, the target noise attenuates to be canceled by the control sound in the exhaust path.

[2.1.4. Effect of Dust Collector]

The dust collector 1 of the present embodiment described in the above achieves the following effects.

(Effect 1) The operating noise from the drive machine 43 generated in the housing 30 is collected by the reference microphone 53 provided adjacent to the drive machine 43. The control sound for canceling the operating noise that is about to propagate outside the housing 30 through the third flow path 36 is output from the control speaker 54 provided in the boundary between the second flow path 35 and the third flow path 36. Accordingly, it is possible to effectively inhibit the operating noise of the dust collector 1 from spreading to the surroundings as unpleasant noise.

(Effect 2) Since the width of the exhaust path in which the operating noise propagates is sufficiently small relative to the wavelength of the operating noise, the operating noise propagates in the exhaust path as a plane wave with wavefronts perpendicular to the axis of the exhaust path. The control speaker 54 is arranged so that the direction of the wavefronts of the control sound and the direction of the wavefronts of the operating noise to be canceled are aligned. Therefore, it is possible to use the control sound to effectively reduce the operating noise in the exhaust path.

(Effect 3) According to the present embodiment, the L-shaped exhaust path is used to arrange the control speaker 54 at a bent portion of the exhaust path, in other words, at the coupling portion between the second flow path 35 and the third flow path 36 that are coupled at right angles to each other. Such use of the bent portion or the coupling portion makes it possible to arrange the control speaker 54 to satisfy the above wavefront alignment condition without crossing the flow path.

[2.1.5. Variation on Speaker Arrangement]

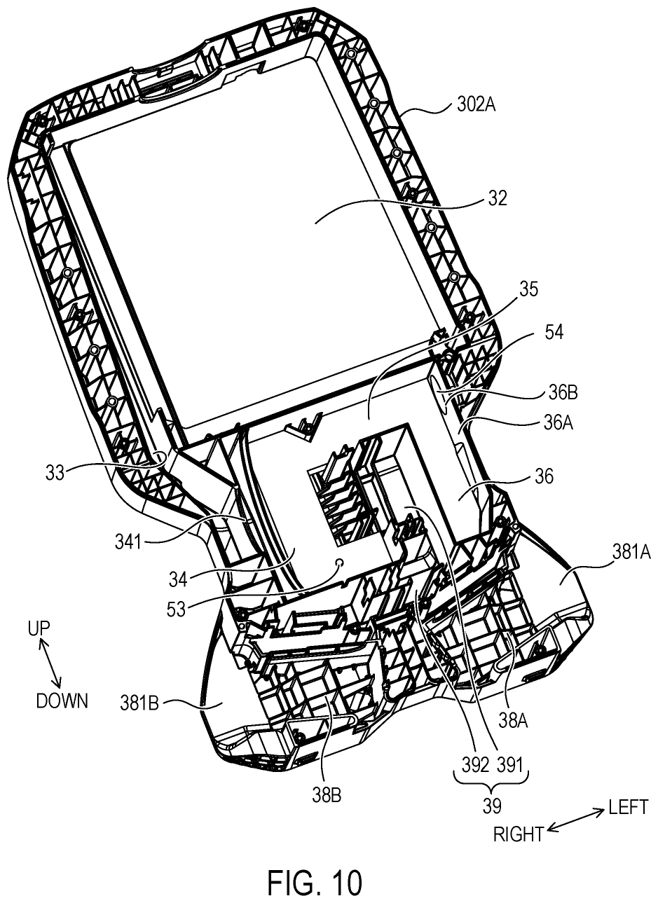

In the aforementioned dust collector 1, arrangement of the control speaker 54 is not limited to the example shown in FIGS. 4 to 7. For example, the control speaker 54 may be arranged as shown in FIGS. 10 to 12.

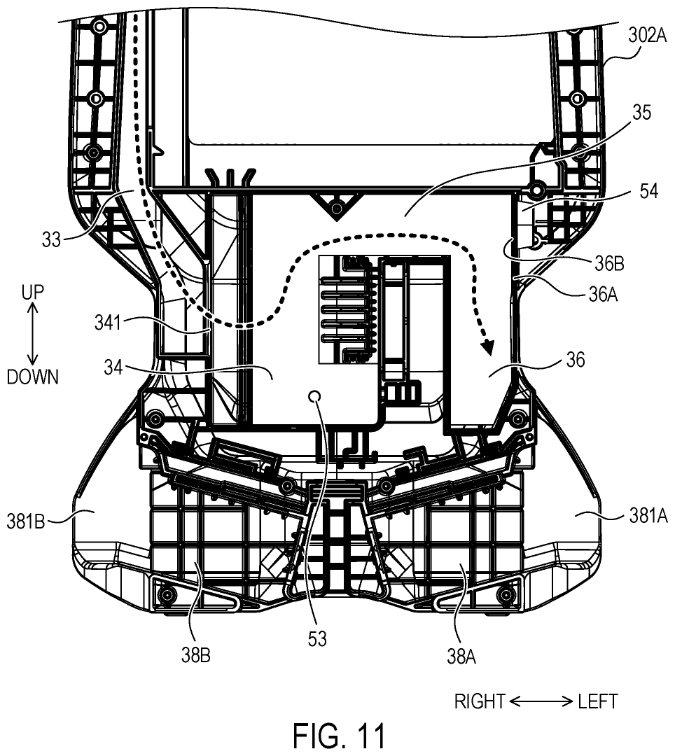

In a variation of the dust collector 1 shown in FIGS. 10 to 12, the front housing 302 shown in FIGS. 4 to 6 is replaced with a front housing 302A shown in FIGS. 10 to 11, and the control speaker 54 is arranged at a different location than the location in the embodiment shown in FIGS. 4 to 6.

As shown in FIGS. 10 and 11, the front housing 302A has a mounting hole 36B, into which the control speaker 54 is fitted, in a left side wall 36A of the third flow path 36. The front housing 302A does not have the mounting hole 35B in the side wall 35A of the second flow path 35, unlike the aforementioned front housing 302.

When mounted to the mounting hole 36B, the control speaker 54 is arranged at a location on the side wall 36A of the third flow path 36 that intersects with the axis extending to the left and right of the second flow path 35, so that the vibrating surface of the control speaker 54 faces the second flow path 35.

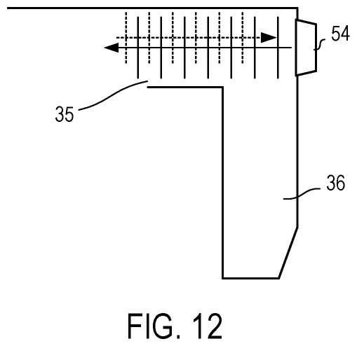

The vibrating surface of the control speaker 54 mounted to the mounting hole 36B is orthogonal to the axial direction of the second flow path 35. This makes the control speaker 54 to output the control sound in the axial direction of the second flow path 35 so that the control sound propagates as a plane wave with wavefronts orthogonal to the axial direction of the second flow path 35, as shown in FIG. 12.

The solid arrow shown in FIG. 12 conceptually represents the propagation direction of the control sound, and the line segments (solid lines) perpendicular to the solid arrow conceptually represent wavefronts of the control sound. The dashed arrow shown in FIG. 12 conceptually represents the propagation direction of the target noise, and the line segments (dashed lines) perpendicular to the dashed arrow conceptually represent wavefronts of the target noise.

As shown in FIG. 12, the target noise that propagates in the second flow path 35 is a plane wave with wavefronts orthogonal to the axial direction of the second flow path 35. The control speaker 54 outputs the control sound from the front side facing the second flow path 35, and does not output the control sound from the back side.

To the target noise that propagates in the second flow path 35 with such a plane wave, the control speaker 54 outputs a plane wave control sound with wavefronts parallel to the wavefronts of the target noise. The propagation direction of the control sound is a direction opposite to the propagation direction of the target noise. The control sound propagates in the direction opposite to the propagation direction of the target noise that propagates to the exhaust port 361, and is reduced to cancel out the target noise.

In the present variation as well, the directions of the wavefronts are aligned between the target noise and the control sound. Thus, the target noise is almost uniformly canceled in the exhaust path by the control sound and reduced. This largely lowers the level of the target noise leaking outside from the exhaust port 361.

### 2.2. Second Embodiment

[2.2.1. Configuration of Blower]

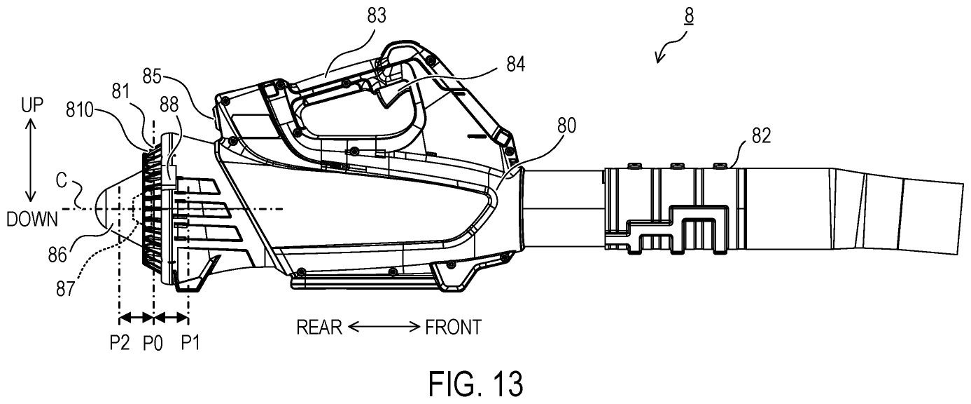

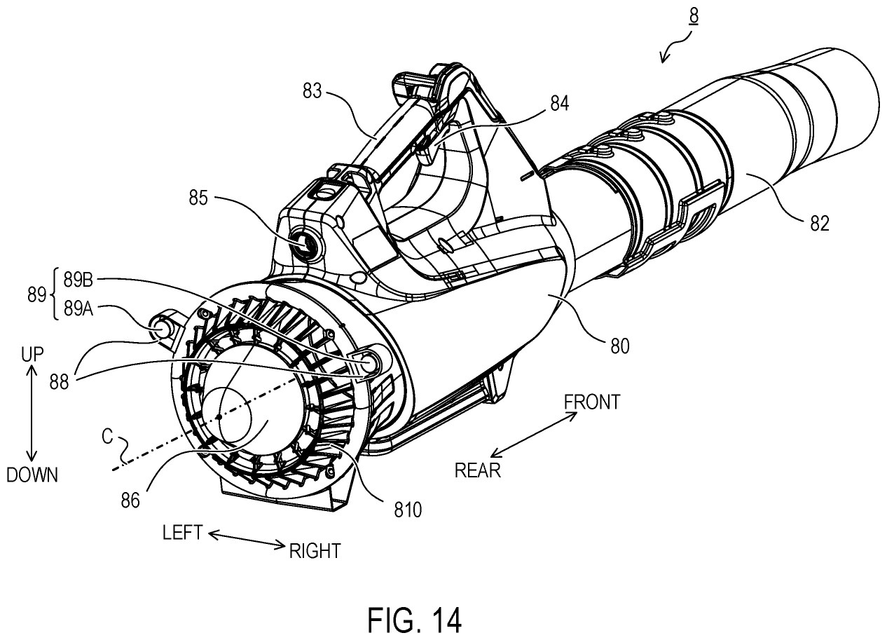

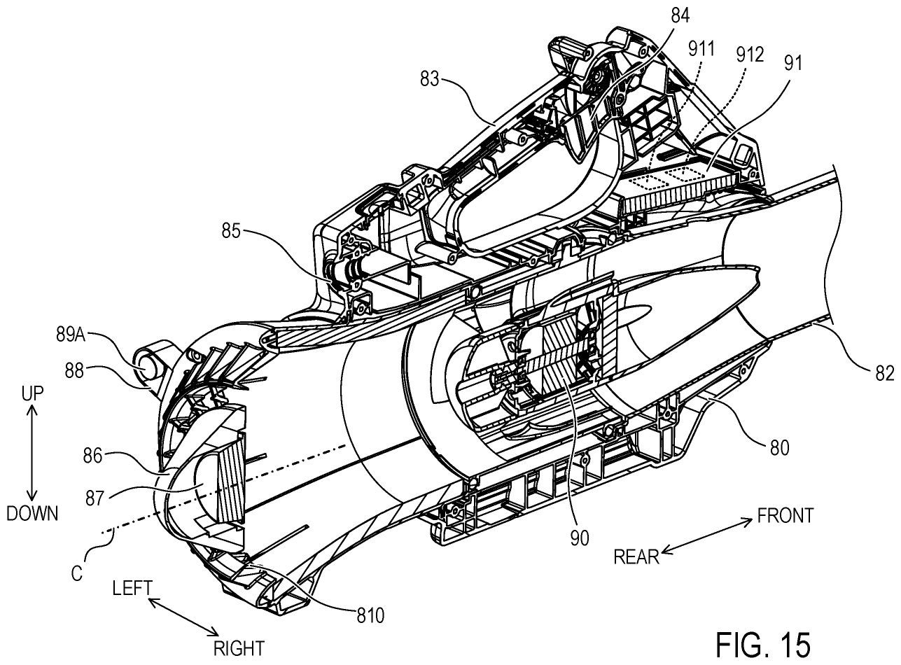

A configuration of a blower 8 will be described hereinafter, as an example of a work machine. For convenience of description, the direction (front, rear, up, down, left and right) relative to the blower 8 is defined as shown in FIGS. 13, 14 and 15 in the present embodiment.

As shown in FIGS. 13, 14 and 15, the blower 8 includes a main housing 80. The main housing 80 includes a suction port 81, a discharge port 82, and a hold part 83. A drive machine 90 and a control circuit board 91 are further provided in the main housing 80.

The suction port 81 is provided in the rear portion of the main housing 80. The discharge port 82 is a cylindrical portion provided in the front portion of the main housing 80. The air sucked from the suction port 81 receives energy by the motion of the drive machine 90 in the main housing 80, and is discharged from the discharge port 82 at high speed.

The hold part 83 is a portion to be gripped by an operator, and is provided in the upper portion of the main housing 80. A trigger switch 84, which the operator can manipulate while holding the hold part 83, is provided to the hold part 83.

A coupling portion 85 for coupling a power cord is provided at the rear portion of the hold part 83. Through the coupling portion 85, electric power is supplied to the electrical components in the main housing 80 which include the drive machine 90 and the control circuit board 91.

The drive machine 90 is provided between the suction port 81 and the discharge port 82 in the main housing 80. The drive machine 90 includes a motor and a fan. The drive machine 90 takes in external air from the suction port 81 by the rotation of the fan, gives energy to the air taken in, and sends out the air at high speed toward the discharge port 82.

In order to inhibit the operating noise generated by the motion of the drive machine 90 from being heard by the operator as noise, the blower 8 is further provided with a control speaker 87 and an error microphone 89.

The control speaker 87 is arranged to have a vibrating surface perpendicular to a center axis C of the suction port 81, and have the center of the vibrating surface on the center axis C of the suction port 81. The control speaker 87 is configured to output a control sound from both sides of the vibrating surface, that is, front and rear sides, by vibration on the vibrating surface.

The control sound generated on the vibrating surface of the control speaker 87 propagates inward, which is a direction toward the inside of the main housing 80, and outward, which is the opposite direction, along the center axis C of the suction port 81.

The control speaker 87 is covered by a cover 86 outside the main housing 80. A slit-shaped lid 810 is attached to the suction port 81, and the cover 86 is arranged in the center of the lid 810.

The error microphone 89 includes microphones 89A, 89B. The microphones 89A, 89B are arranged on concentric circles equidistant from the center axis C of the suction port 81. Mounting portions 88 for the microphones 89A, 89B are provided around the slit-shaped lid 810. The microphones 89A, 89B are mounted to the mounting portion 88 so as to be arranged on the concentric circles equidistant from the center axis C of the suction port 81.

Sound signals from the microphones 89A, 89B are synthesized. The synthesized signal is used for ANC in the control circuit board 91 as a sound signal from the error microphone 89. The sound signals as analog signals output from the microphones 89A, 89B may be synthesized, or may be first converted to digital signals and synthesized thereafter. According to one example, the error microphone 89 may be configured by a single microphone. Variations of the blower 8 may include an example in which the error microphone 89 includes only one of the microphones 89A, 89B.

The control circuit board 91 includes a motor controller 911 and a noise controller 912. The motor controller 911 is configured to control the motor of the drive machine 90 in accordance with the operator's manipulation of the trigger switch 84. The noise controller 912 is configured to reduce the operating noise generated by the motion of the drive machine 90 as target noise.

The noise controller 912 has a configuration corresponding to those of the A/D converter 445 and the D/A converter 446 shown in FIG. 8, and the control circuit 441 The noise controller 912 implements feedback ANC together with the control speaker 87 and the error microphone 89.

[2.2.2. ANC Model]

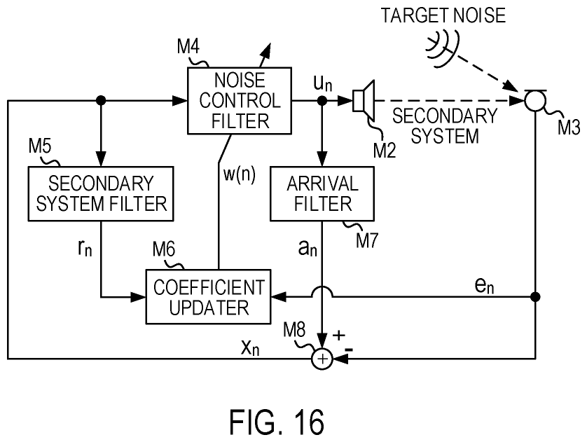

Referring to FIG. 16, a feedback ANC model applied to the blower 8 will be described. The feedback ANC model implemented by the noise controller 912 merely partly differs from the feed-forward ANC model described by way of FIG. 9. Accordingly, the same reference numerals are affixed to components of the feedback ANC model configured in the same manner as those of the feed-forward ANC model, and descriptions thereof are not repeated.

As shown in FIG. 16, the feedback ANC model differs from the feed-forward ANC model in that the feedback ANC model does not have the reference sensor M1 but an arrival filter M7 and an adder M8. The control sound source M2 corresponds to the control speaker 87 and the D/A converter 446, and the error sensor M3 corresponds to the error microphone 89 and the A/D converter 445.

The noise control filter M4, the secondary system filter M5, the coefficient updater M6, the arrival filter M7, and the adder M8 may be implemented by processing of a microcomputer when the noise controller 912 includes the microcomputer, or may be partly or entirely implemented by hardware.

The newly added arrival filter M7 has the same configuration as that of the secondary system filter M5, and estimates an arrival signal aₙ from the N control signals uₙ that are most recently calculated. The arrival signal aₙ represents pseudo-noise that has arrived to the error sensor M3 from the control sound source M2. According to one example, the same fixed value as that for the secondary system filter M5 may be used as the coefficient of each tap in the arrival filter M7.

The adder M8 subtracts the error signal eₙ from the arrival signal aₙ to estimate a reference signal xₙ that represents target noise. In other words, in the feedback ANC model, instead of the result of the detection by the reference sensor M1, the estimated result based on the control signals uₙ and the error signal eₙ is used as the reference signal xₙ.

The coefficient updater M6 updates coefficients {w₁, w₂, . . . , w_{L}} of L taps included in the noise control filter M4 based on the filtered reference signal rₙ obtained from the estimated reference signal xₙ and the error signal eₙ, so that the target noise and the control sound cancel each other out at the position of the error sensor M3 (that is, noise canceling point), and the error signal eₙ becomes the smallest. This updating of the coefficient causes the target noise to be canceled by the control sound outside the main housing 80 from the suction port 81.

[2.2.3. Arrangement of Microphone and Speaker]

In order to cancel the target noise, which is generated in the drive machine 90 and propagates outside the main housing 80 from the suction port 81, with the control sound, and reduce propagation of the target noise outside the main housing 80, the control speaker 87 and the error microphone 89 are arranged as below.

The control speaker 87 is arranged to have a vibrating surface parallel to the boundary plane P0 between inside and outside the main housing 80 defined by the suction port 81 which is the open end of the main housing 80.

The boundary plane P0 is a virtual plane perpendicular to the center axis C of the suction port 81, specifically a plane passing through the circular edge perpendicular to the center axis C of the suction port 81. The control speaker 87 is arranged so that the vibrating surface is on the boundary plane P0, or the vibrating surface is located at a distance from the boundary plane P0 in the forward and rearward direction.

The error microphone 89 is arranged so that a sound collection point is positioned in a section centered on the vibrating surface of the control speaker 87, the section where the width in a direction normal to the vibrating surface is less than a specific distance D. Specifically, the error microphone 89 is arranged so that the sound collection point is positioned in a space between a plane P1 at half the specific distance D away from the vibrating surface toward the inside of the main housing 80 and a plane P2 at half the specific distance D away from the vibrating surface toward the outside of the main housing 80. FIG. 13 shows the planes P1, P2, assuming that the vibrating surface of the control speaker 87 is on the boundary plane P0.

The specific distance D is a quarter wavelength or one-sixth wavelength of the operating noise to be reduced, that is, the target noise. The operating noise generally includes the operating noise in the 1 kHz band or higher. When the speed of sound is 340 m/s, the wavelength of the sound is 340 mm. Accordingly, the error microphone 89 is arranged so that the sound collection point is in a section with a width of approximately 85 mm or 56.6 mm centered on the vibrating surface.

When the error microphone 89 is arranged so that the sound collection point is within one-sixth wavelength width centered on the vibrating surface of the control speaker 87, it is possible to more effectively reduce the target noise, as compared to a case where the error microphone 89 is arranged so that the sound collection point is within a quarter wavelength width centered on the vibrating surface of the control speaker 87. Furthermore, when the vibrating surface of the control speaker 87 and the sound collection point of the error microphone 89 are on the same plane, especially on the boundary plane P0, the target noise is more effectively reduced.

Here, why the arrangement of the control speaker 87 and the error microphone 89 under the above conditions is meaningful will be explained by theory. Generally, the sound pressure distribution of sound propagating in an acoustic tube can be expressed by the following formula. “k” is a wavenumber and k=2π/λ. “λ” corresponds to the wavelength of sound.

p₁(t,x)=A₁e^{j(ωt-kx)}

The above corresponds to a sound pressure distribution of the target noise that propagates from the drive machine 90 to the suction port 81 in the tubular path in the main housing 80. The forward direction of a variable x corresponds to the travelling direction of the target noise, and also corresponds to the direction from inside to outside the main housing 80.

The sound pressure distribution of the control sound from the control speaker 87 can be expressed as below. The point where the variable x is zero is the point where there is the vibrating surface of the control speaker 87.

$${p}_{2} ( t , x ) = \{ \begin{matrix}{A}_{2} {e}^{j ( ω t - kx + φ )} & ( x \geq 0 ) \\ {A}_{2} {e}^{j ( ω t + kx + φ )} & ( x < 0 )\end{matrix}$$

Accordingly, a combined sound at a point x=d (d<0), which is at a distance d away from the vibrating surface toward the inside of the main housing 80, will be expressed by the following formula.

p₁(t,d)+p₂(t,d)=A₁e^{j(ωt-kd)}+A₂e^{j(ωt+kdφ)}

The condition where the combined sound at the point x=d becomes zero is as follows.

A₁=A₂

ωt−kd+π=ωt+kd+φ

In case that the aforementioned condition is satisfied, the sound pressure distribution on the outside of the main housing 80 from the vibrating surface is expressed as follows.

p₁(t,x)+p₂(t,x)=A₁e^{j(ωt-kx)}(1+e^{j(π-2kd)})

Accordingly, when an inequation −π/2<2kd<π/2 is satisfied, the target noise is reduced outside the main housing 80, as compared to a case where ANC is not performed.

The above inequation is satisfied when the distance d between the vibrating surface of the control speaker 87 and the sound collection point of the error microphone 89 is d<λ/8, that is, less than one-eighth wavelength of the target noise, specifically when the error microphone 89 is in a section narrower than a width corresponding to a quarter wavelength of the target noise centered on the vibrating surface of the control speaker 87.

Theoretically, the target noise is reduced to less than half, as compared to when ANC is not performed, when the distance d is less than one-twelfth wavelength of the target noise, that is, when the error microphone 89 is in a section narrower than a width corresponding to one-sixth wavelength of the target noise centered on the vibrating surface of the control speaker 87.

[2.2.4. Effect of Blower]

The blower 8 of the present embodiment described in the above achieves the following effects.

(Effect 1) The operating noise from the drive machine 90 generated in the main housing 80 is canceled by a control sound from the control speaker 87 installed at the suction port 81 which is the end of the path extending from the drive machine 90. Accordingly, it is possible to effectively reduce the operating noise of the blower 8 from being audible to the operator behind the blower 8 as unpleasant noise.

(Effect 2) Since the error microphone 89 is arranged within a quarter wavelength of the operating noise centered on the vibrating surface of the control speaker 87, the operating noise can be effectively reduced. Especially, when the error microphone 89 is arranged within one-sixth wavelength of the operating noise centered on the vibrating surface, the operating noise can be all the more effectively reduced.

### 3. Others

(3.1) The technique of the present disclosure is not limited to application to the dust collector 1 and the blower 8. The technique of the present disclosure may be applied to a work machine used in, for example, home carpentry, manufacturing, gardening, and/or construction work sites, in particular to a work machine that uses airflow from a fan. The technique of the present disclosure may be applied to a working machine for gardening, and/or a work machine that prepares a work site environment. For example, the technique of the present disclosure may be applied to various electric work machines such as electric lawn mower, electric grass trimmer, electric grass cutter, electric cleaner, electric blower, electric sprayer, electric spreader, electric dust collector, etc.

(3.2) A plurality of functions performed by a single element in the above-described embodiments may be achieved by a plurality of elements, or a function performed by a single element may be achieved by a plurality of elements. Also, a plurality of functions performed by a plurality of elements may be achieved by a single element, or a function performed by a plurality of elements may be achieved by a single element. Further, a part of a configuration in the above-described embodiments may be omitted. At least a part of a configuration in the above-described embodiments may be added to, or may replace, another configuration in the above-described embodiments.

What is claimed is:

1. A dust collector comprising:
a drive machine for dust collection including a motor and a fan connected to a rotation shaft of the motor;
a housing that houses the drive machine, the housing including an exhaust port;
an exhaust path inside the housing for guiding an airflow generated from the fan by motion of the drive machine to the exhaust port located downstream;
a speaker; and
a controller configured to cause the speaker to output a control sound for reducing operating noise, the operating noise being generated in the housing by the motion of the drive machine and propagating in the exhaust path from the drive machine to the exhaust port,
the exhaust path being designed so that the operating noise that propagates in the exhaust path forms a plane wave with a wavefront orthogonal to an axial direction of the exhaust path,
the exhaust path including a first linear path and a second linear path,
the second linear path is coupled to the first linear path at right angles,
the speaker being arranged to face the first linear path or the second linear path on a side wall of a coupling portion between the first linear path and the second linear path in the exhaust path, and
the speaker outputting the control sound in an axial direction of the first linear path or the second linear path so that the control sound propagates in the exhaust path as a plane wave with a wavefront orthogonal to the axial direction of the exhaust path.

2. A work machine comprising:
a machine;
a housing that at least partly houses the machine, the housing having an opening;
a path leading into the housing from the opening;
a speaker; and
a controller configured to cause the speaker to output a control sound for reducing operating noise, the operating noise being generated in the housing by motion of the machine and propagating in the path from a source of the operating noise to the opening,
the speaker being arranged so that the control sound propagates in the path with its wavefront parallel to a wavefront of the operating noise that propagates in the path.

3. The work machine according to claim 2, wherein
the path is designed so that the operating noise that propagates in the path forms a plane wave with a wavefront orthogonal to an axial direction of the path, and
the speaker outputs the control sound in the axial direction of the path so that the control sound propagates as a plane wave with a wavefront orthogonal to the axial direction of the path.

4. The work machine according to claim 2, wherein
the path includes a first linear path and a second linear path,
the second linear path is coupled to the first linear path at an angle to the first linear path, and
the speaker is arranged to face the first linear path or the second linear path on a side wall of a coupling portion between the first linear path and the second linear path in the path, and outputs the control sound in an axial direction of the first linear path or the second linear path.

5. The work machine according to claim 3, wherein
the path includes a first linear path and a second linear path,
the second linear path is coupled to the first linear path at an angle to the first linear path, and
the speaker is arranged to face the first linear path or the second linear path on a side wall of a coupling portion between the first linear path and the second linear path in the path, and outputs the control sound in an axial direction of the first linear path or the second linear path.

6. The work machine according to claim 4, wherein the second linear path is coupled to the first linear path at right angles.

7. The work machine according to claim 5, wherein the second linear path is coupled to the first linear path at right angles.

8. The work machine according to claim 2, wherein the speaker is arranged so as to output the control sound in a same direction as a propagation direction of the operating noise that propagates to the opening.

9. The work machine according to claim 3, wherein the speaker is arranged so as to output the control sound in a same direction as a propagation direction of the operating noise that propagates to the opening.

10. The work machine according to claim 4, wherein the speaker is arranged so as to output the control sound in a same direction as a propagation direction of the operating noise that propagates to the opening.

11. The work machine according to claim 5, wherein the speaker is arranged so as to output the control sound in a same direction as a propagation direction of the operating noise that propagates to the opening.

12. The work machine according to claim 6, wherein the speaker is arranged so as to output the control sound in a same direction as a propagation direction of the operating noise that propagates to the opening.

13. The work machine according to claim 7, wherein the speaker is arranged so as to output the control sound in a same direction as a propagation direction of the operating noise that propagates to the opening.

14. The work machine according to claim 2, wherein the speaker is arranged so as to output the control sound in a direction opposite to a propagation direction of the operating noise that propagates to the opening.

15. The work machine according to claim 3, wherein the speaker is arranged so as to output the control sound in a direction opposite to a propagation direction of the operating noise that propagates to the opening.

16. The work machine according to claim 4, wherein the speaker is arranged so as to output the control sound in a direction opposite to a propagation direction of the operating noise that propagates to the opening.

17. The work machine according to claim 5, wherein the speaker is arranged so as to output the control sound in a direction opposite to a propagation direction of the operating noise that propagates to the opening.

18. The work machine according to claim 6, wherein the speaker is arranged so as to output the control sound in a direction opposite to a propagation direction of the operating noise that propagates to the opening.

19. The work machine according to claim 7, wherein the speaker is arranged so as to output the control sound in a direction opposite to a propagation direction of the operating noise that propagates to the opening.
